(19) United States
(12) Patent Application Publication
(10) Pub. No.: US 2015/0153918 A1
(43) Pub. Date: Jun. 4, 2015

(54) SYSTEM AND METHOD FOR DASHBOARD SOFTWARE MAINTAINED BY AN END USER

(71) Applicant: General Electric Company, Schenectady, NY (US)

(72) Inventors: Li Ye Chen, Shelton, CT (US); James Blomberg, Fairfield, CT (US)

(73) Assignee: General Electric Company, Schenectady, NY (US)

(21) Appl. No.: 14/096,903

(22) Filed: Dec. 4, 2013

(51) Int. Cl. G06F 3/0484; G06F 17/30

(52) U.S. Cl. CPC G06F 3/0484; G06F 17/30312

(57) ABSTRACT

A digital dashboard application extracts data, performs data processing on the extracted data, and displays the analyzed data as widgets in a dashboard format. The digital dashboard application may access a widget library, from which an end user may download a widget to add to the application. In certain embodiments, the digital dashboard application may be installed, set up, and maintained by an end user.

### BACKGROUND

The subject matter disclosed herein relates generally to business data visualization software. Specifically, the embodiments described relate to business dashboard software.

Many companies use data analysis to evaluate progress towards quantifiable goals and measure company success. Traditionally, relevant data would be stored in a database and periodically the company would analyze the data and submit the findings in a report. This method could be slow and expensive, especially when considering different facets of the process, such as the numerous types of data that might need to be analyzed, or that some companies might outsource the task to an outside firm.

In recent years, analytics firms have developed business data visualization software specifically for displaying analyzed business data, as well as other types of software intended to automate portions of the data aggregation and analysis process. However, the current state of business data visualization software still presents a range of issues.

Often in business data visualization software, there is a tradeoff between the various ways a user can view analyzed data and the amount of types of analyzed data the software can support. For example, users may have a myriad of options for how to display analyzed data, but a limited amount of types of analyzed data that can be displayed. On the other hand, the software may support many different types of analyzed data, but only includes a few options for how that analyzed data is displayed. Further, regardless of how customizable the software is, it may still require a lot of time, effort, and/or computer skills for the user to change the existing set-up.

If a business data visualization software program can support only a limited range of data types, then it may be difficult for the software to incorporate disparate types of data. As a result, different versions of the software may be required based on the types of analyzed data that might be displayed. For example, a company may license a business data visualization software program, but may have different versions of the software for various internal divisions (e.g., executives, finance, marketing, etc.). Multiple versions of the software may be more expensive and make it difficult to share analyzed data with other users within the company.

Additionally, some business data visualization software only displays the analyzed data, relying on users to aggregate and analyze the data supplied to the software. Some existing software does automate data aggregation, but those programs do not necessarily include further data processing, such as data validation to ensure that the data is reliable, or formatting data into a standard data format. Other software only automates certain types of data analysis.

There may also be issues with how accessible the business data visualization software is, and how well it allows users to connect with one another. In many cases, an information technology (IT) consultant may be required in order to ensure correct installation and set up of the business data visualization software. The installed software may only be accessible on work computers, and the software may be able to share analyzed data only within a select group of users or not at all.

Finally, the business data visualization software may only present analyzed data, but does not necessarily provide a link to making decisions based on that data. For example, a user may be able to see how popular a video series is, but he or she may have to check the software regularly to determine if and when they can expect to meet their target popularity level. Another example is that the user may need to regularly check the software to determine if the popularity level of the video series falls below a certain limit, which would likely trigger a contingency plan such as creating a new promotion.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system may include a processor, memory, a display and a user input device. The processor may be configured to access a widget library layer that includes a first data structure including a first plurality of widgets and may also be configured to control a digital dashboard software. The digital dashboard software may include a data connections layer that includes a first set of algorithms configured to extract data from a first plurality of data sources, wherein the data from the first plurality of data sources is stored outside of the system. The digital dashboard layer may also include a services layer that includes a second set of algorithms configured to perform at least one of validation, clustering, or analysis on data and a widget definitions layer that includes a second data structure including a first set of data associated with a second plurality of widgets. Further, the digital dashboard software may include a dashboard layer that includes a user interface structure including a plurality of user interfaces, a visualizations layer that includes a third data structure including a first plurality of visualizations, and a team layer that includes a fourth data structure including a second set of data associated with a plurality of contacts. The processor may be configured to download a first widget of the first plurality of widgets and store the first widget and a third set of data associated with the first widget within the digital dashboard software in response to end user input. Further, at least one of the first plurality of data sources, the second set of algorithms, the second plurality of widgets, or the plurality of contacts may be configured to be edited by an end user.

In a second embodiment, a non-transitory computer-readable medium may store computer executable code that includes instructions to access a widget library layer that includes a first data structure includes a first plurality of widgets. The computer executable code may also include instructions to run a digital dashboard application. The digital dashboard application may include a data connections layer that includes a first set of algorithms configured to extract data from a first plurality of data sources, wherein the data from the first plurality of data sources is stored outside of the non-transitory computer-readable medium. The digital dashboard application may also include a services layer that includes a second set of algorithms configured to perform at least one of validation, clustering, or analysis on extracted data and a widget definitions layer that includes a second data structure including a first set of data associated with a second plurality of widgets. Further, the digital dashboard application may include a dashboard layer that includes a user interface structure including a plurality of user interfaces, a visualizations layer that includes a data structure including a first plurality of visualizations, and a team layer that includes a fourth data structure including a second set of data associated with a plurality of contacts. The computer executable code may also include instructions to download a first widget of the first plurality of widgets and store the first widget and a third set of data associated with the first widget within the digital dashboard application in response to end user input.

In a third embodiment, a method includes accessing a first plurality of widgets stored outside of a system and extracting data from a first plurality of data sources according to a first set of algorithms, wherein the data is stored outside of the system. The method also includes performing an action on the extracted data according to a second set of algorithms, wherein the action comprises at least one of validation, clustering, or analysis, and displaying a second plurality of widgets. Further, the method includes organizing the second plurality of widgets in response to user input and editing the second plurality of widgets and a first set of data associated with the second plurality of widgets. The method also includes displaying a plurality of contacts and sharing a first widget of the second plurality of widgets with a contact of the plurality of contacts. Further, the method includes downloading a second widget of the first plurality of widgets and storing the second widget and a second set of data associated with the widget within the system.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a computer system, in accordance with an embodiment of the present approach;

FIG. 2 is a screenshot of a user interface of a business dashboard software program, in accordance with an embodiment of the present approach;

FIG. 3 is a block diagram of a business dashboard software, in accordance with an embodiment of the present approach;

FIG. 4 is a screenshot of a dashboard interface within the dashboard layer of the business dashboard software of FIG. 3, in accordance with an embodiment of the present approach;

FIG. 5 is a block diagram of the data connection layer of the business dashboard software of FIG. 3, in accordance with an embodiment of the present approach;

FIG. 6 illustrates the action of opening the data source interface, in accordance with an embodiment of the present approach;

FIG. 7 is a screenshot of a data source interface within the dashboard layer of the business dashboard software of FIG. 3, in accordance with an embodiment of the present approach;

FIG. 8 is a process diagram illustrating the action of adding a data source via the data source interface of FIG. 7, in accordance with an embodiment of the present approach;

FIG. 9 is a screenshot of a data source interface within the dashboard layer of the business dashboard software of FIG. 3, in accordance with another embodiment of the present approach;

FIG. 10 is a block diagram of the services layer of the business dashboard software of FIG. 3, in accordance with an embodiment of the present approach;

FIG. 11 is a screenshot of a services interface within the dashboard layer of the business dashboard software of FIG. 3 in accordance with an embodiment of the present approach;

FIG. 12 illustrates the action of rearranging widgets in the dashboard interface, in accordance with an embodiment of the present approach;

FIG. 13 is a screenshot of a dashboard interface within the dashboard layer of the business dashboard software of FIG. 3, in accordance with another embodiment of the present approach;

FIG. 14 is a screenshot of the selection interface within the dashboard layer of the business dashboard software of FIG. 3, in accordance with an embodiment of the present approach;

FIG. 15 is a screenshot of a widget library interface within the dashboard layer of the business dashboard software of FIG. 3, in accordance with an embodiment of the present approach;

FIG. 16 is a screenshot of a widget editing interface within the dashboard layer of FIG. 3, in accordance with an embodiment of the present approach;

FIG. 17 is a screenshot of a dashboard interface within the dashboard layer of the business dashboard software of FIG. 3, in accordance with yet another embodiment of the present approach; and

FIG. 18 is a screenshot of a contacts interface within the dashboard layer of the business dashboard software of FIG. 3, in accordance with an embodiment of the present approach.

### DETAILED DESCRIPTION

One or more specific embodiments of the present subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. The term “metric” refers to a specific set of analyzed data, and the term “widget” refers to a collection of related metrics. The term “component” refers to a computer-related entity, either a combination of hardware and software, software, or software in execution. The term “end user” is intended to refer to a layperson that would not typically possess the programming or software engineering knowledge that a specialist (e.g., programmer, software developer, information technology (IT) technician) would posses.

Present embodiments may relate to implementations of business data visualization software. Specifically, the embodiments described herein may relate to business dashboard software. The business dashboard software may be used to display metrics for a wide variety of business applications (e.g., human resources, careers, and recruiting insights; global growth and market insights; brand monitoring pre- and post-earnings; external issues and threat monitoring, etc.). The business dashboard software may automate data aggregation, validation, and analysis, and may provide a plethora of options to display a large range of types of metrics. The business dashboard software may generally be accessible from a wide variety of devices, and may also be installed, set up, and maintained by an end user. Further, the business dashboard software may also enable sharing of analyzed data between end users and alerts based on changes in analyzed data. It should be appreciated that the illustrated business dashboard software is merely an example, and that the embodiments described herein may be employed in any type of dashboard software.

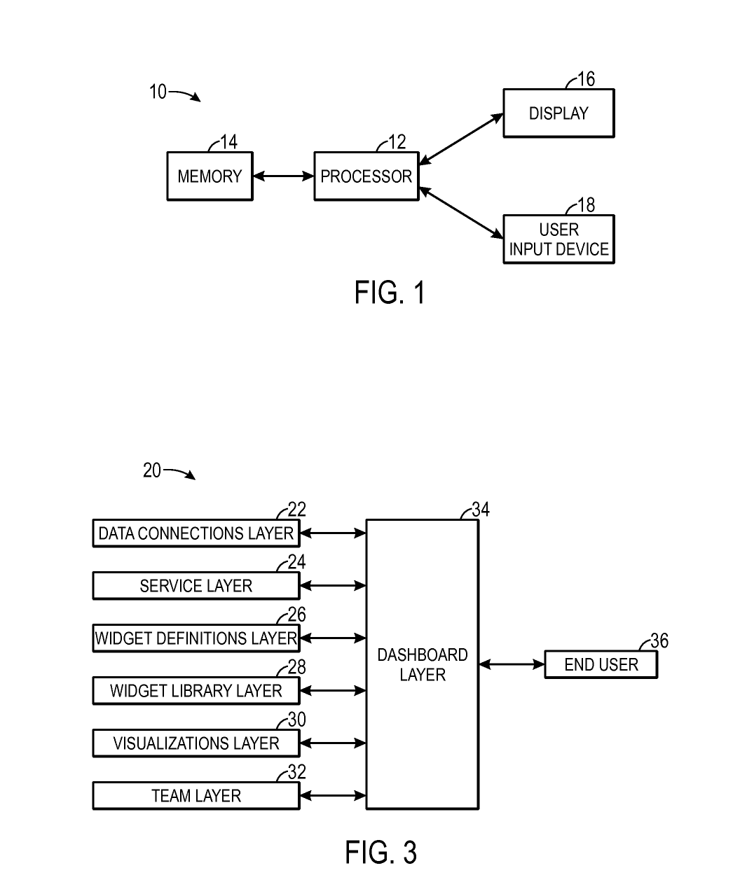

With the foregoing in mind, FIG. 1 illustrates a computer system 10 on which business data visualization software may run. The computer system 10 may include a processor 12 and memory 14. The processor 12 may include, for example, general-purpose single- or multi-chip microprocessors. In addition, the processor 12 may be any conventional special-purpose processor, such as an application-specific processor or circuitry. The processor 12 and/or other data processing circuitry may be operably coupled to memory 14 to execute instructions for running the business data visualization software. For example, these instructions may be encoded in programs that are stored in memory 14, which may be an example of a tangible, non-transitory computer-readable medium, and may be accessed and executed by the processor 12 to allow for the presently disclosed techniques to be performed. The memory 14 may be a mass storage device, a FLASH memory device, removable memory, or any other non-transitory computer-readable medium. Additionally and/or alternatively, the instructions may be stored in an additional suitable article of manufacture that includes at least one tangible, non-transitory computer-readable medium that at least collectively stores these instructions or routines in a manner similar to the memory 14 as described above. The system 10 may also include a display 16 for an end user to view the business data visualization software and a user input device 18 (e.g., a keyboard, mouse, touchscreen, gesture input device, etc.) to allow the end user to interact with the business data visualization software.

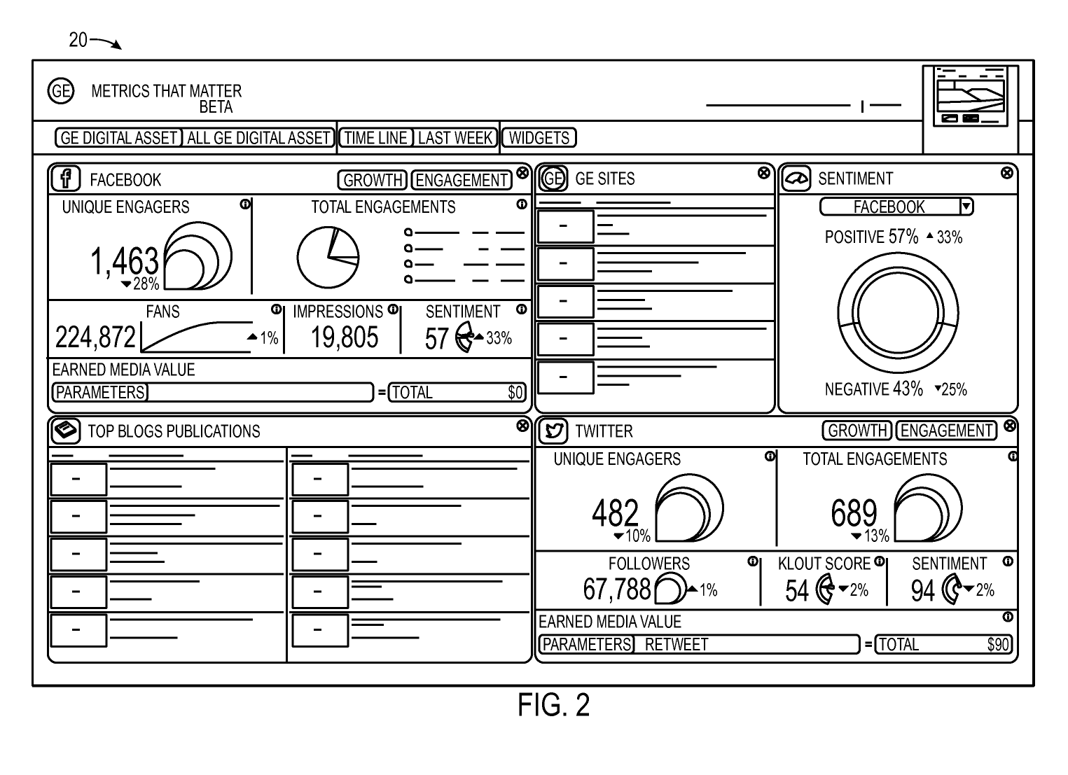

A business dashboard software program 20 is a particular type of business data visualization software characterized by displaying disparate types of metrics in a format similar to the dashboards found in vehicles, as illustrated in FIG. 2. The business dashboard software 20 may be used to display many categories of metrics (e.g., human resources, careers, and recruiting insights; global growth and marketing insights; brand monitoring pre- and post-earnings; external issues and threat monitoring; etc.).

The business dashboard software 20 may be designed such that it can be configured and maintained by an end user. That is, an end user may be able to install the software, select the contents of the dashboard software, modify the dashboard software, and perform other actions described in more detail below. As such, specialists such as IT technicians may not be required to use the dashboard software 20 except for special circumstances, such as troubleshooting.

In some embodiments, the business dashboard software 20 may be accessible via a web browser. For example, once a company has purchased or licensed the business dashboard software, the company may be provided with a uniform resource locator (URL) to a secure website hosting the business dashboard software 20. The business dashboard software 20 may also be an application that can be installed on a device and run outside of a web browser. In such a case, a company may purchase or license the business dashboard software 20, and may then be provided with a URL to a secure website from which the company may download the software.

In other embodiments, the business dashboard software 20 may be available both as a website accessible by a web browser as well as a program that may be installed on a device and run outside of a web browser. As a result, the manner in which the business dashboard software 20 is accessed may depend on the needs and desires of the end user as well as the type of device being used to access the business dashboard software 20. Additionally, the business dashboard software 20 may include a sync function that, regardless of the device the end user is on, saves any changes made by an end user to an offsite server.

The business dashboard software 20 may include a layered architecture, wherein each layer is a data or user interface structure or a set of algorithms that manages one or more features of the software. The business dashboard software may contain a data connections layer 22, a services layer 24, a widget definitions layer 26, a widget library layer 28, a dashboard layer 30, a visualizations layer 32, and a team layer 34. An end user 36 may interact with the dashboard layer 30, which may communicate with the other components of the dashboard software 20, as illustrated in FIG. 3. In certain embodiments, the dashboard software 20 may be configured such that all of the actions available to the end user 36 are confined within the dashboard layer 34. Further, any interactions requiring direct access to the other layers may be restricted to specialists (e.g., software developer, (IT) technician, etc.). As mentioned above and described in detail below, most or all of the actions regarding installation, set-up and modification of the dashboard software 20 may be performed by an end user, advantageously reducing or eliminating a possible need for specialized computer knowledge.

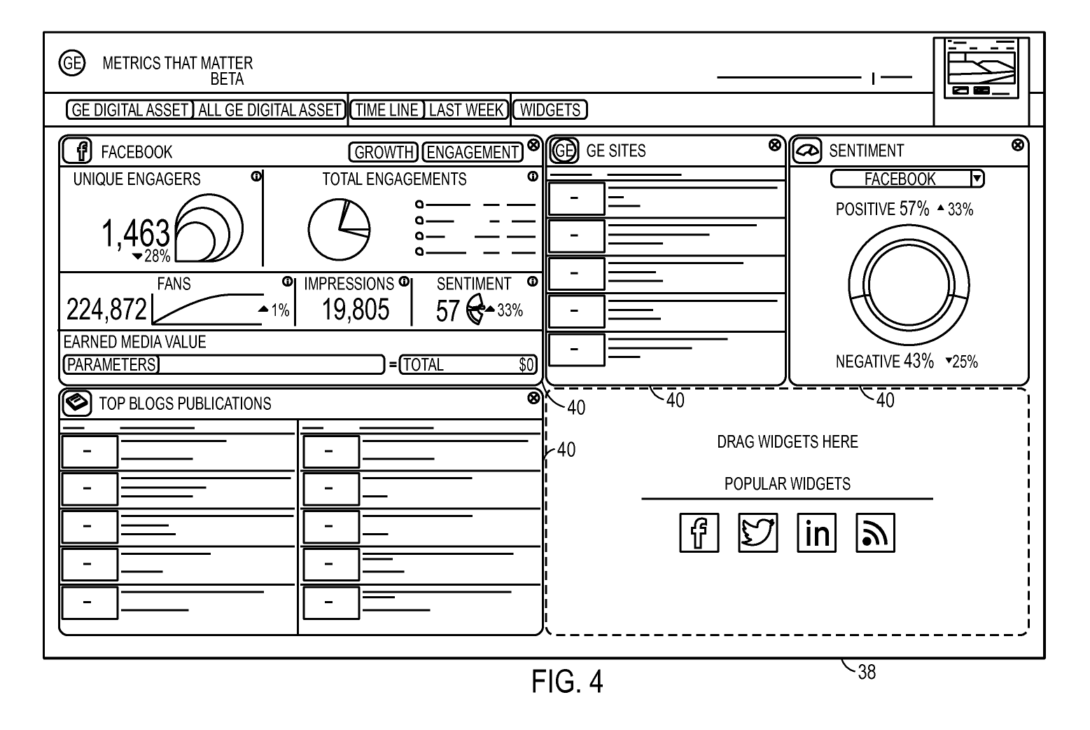

The dashboard layer 34 may include a user interface structure which controls the various interfaces presented to an end user. Within the dashboard layer 34, the end user 36 may interact primarily with a dashboard interface 38, as illustrated in FIG. 4. The metrics displayed in the dashboard interface 38 may generally be organized into one or more widgets 40. For example, a Facebook widget might include analyzed data regarding Facebook engagement, Facebook likes, and Facebook posts. As will be discussed in further detail below, the widgets 40 may be customizable by the end user 36, and in some embodiments may be automatically generated by the dashboard software 20. Further, the end user 36 may rearrange the widgets 40 within the dashboard interface 38. The end user 36 may also perform other actions on the widget 40 or the associated metrics, such as setting alerts based on the state of the metric.

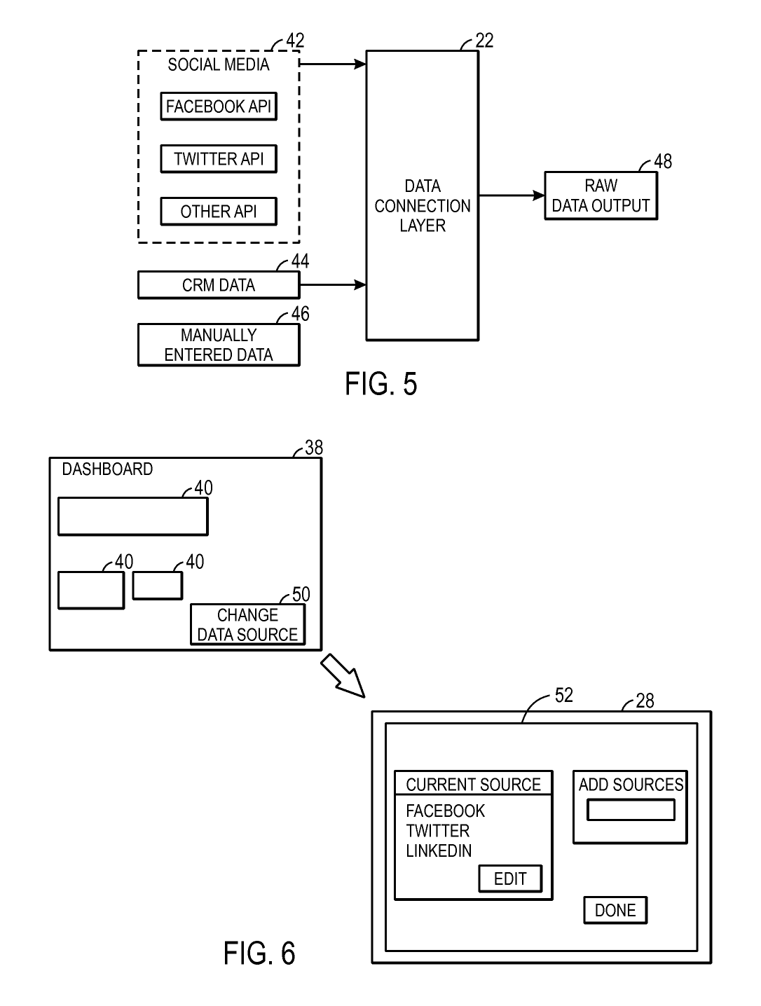

Turning now to FIG. 5, the data displayed in the widgets 40 may first be aggregated in the data connections layer 22. The data connections layer 22 may be a data processing structure that gathers data from a wide variety of sources and outputs the raw data. The data sources may be a 3^{rd} party data source 42, a proprietary data source 44, or a manual data source 46.

The 3^{rd} party data sources 42 may be open data sources, in that access or use of the data provided is not restricted by various control mechanisms (e.g., copyrights, fee structures attached to databases, etc.). For example, a 3^{rd} party data source 42 may constitute social media websites such as Facebook, Twitter, or LinkedIn. Alternately and additionally, the 3^{rd} party data sources may include data sources that are restricted by various control mechanisms. Examples of a proprietary data source 44 may include, but are not limited to, a customer relationship management (CRM) database or an inventory management application.

The 3^{rd} party data sources 42 and the proprietary data sources 44 may provide data via an application programming interface (API). As will be appreciated by those skilled in the art, an API is a way of describing the data provided by the data source and, as such, may take on many different forms based on the software the API is used for. The data connection layers 22 may include algorithms to connect to and understand the APIs used by the 3^{rd} party data sources 42 and the proprietary data sources 44. The data connection layers 22 may then extract raw data 48 from the data sources. The set of algorithms in the data connections layer 22 may include common algorithms that can be applied to most APIs, and API-specific algorithms to deal with API-specific issues. Since the data connection layer 22 may aggregate data via algorithms and APIs, the dashboard software 20 may collect new data as often as the data sources update which, especially in terms of 3^{rd} party sources 42 such as websites, may be in real-time.

As will be appreciated by those skilled in the art, the data provided by 3rd party sources 42 and proprietary sources 44 may generally be stored in one or more databases. In contrast, a manual data source 46 may be a data source whose data is not stored in a database. Instead, the corresponding data is entered by the end user 36, as described below. The manual data source 46 may be preferred when the end user does not wish to set up and maintain a database, API, or batch data feed; or when the data in question corresponds to an irregular event. For example, the end user 36 may wish to create a metric representing the time spent in meetings per day; in such a case, the manual data source 46 allows the end user to record the data without requiring him or her to set up and maintain a database.

If the end user 36 wishes to add or change the data sources used by the dashboard software 20, he or she may do so via a data source interface within the dashboard layer 34. The end user may select a data source button 50 on the dashboard interface 38 to prompt the data source interface 52, as illustrated in FIG. 6. As discussed below, the data source interface 52 may also be accessed via other interfaces, such as a widget editing interface. Alternately or additionally, the end user 36 may select a widget 40 to prompt a list of actions that includes editing the data sources associated with the widget via the data source interface 52. Advantageously, the end user 36 may have complete control over the data sources available to the dashboard software 20 via the data source interface 52.

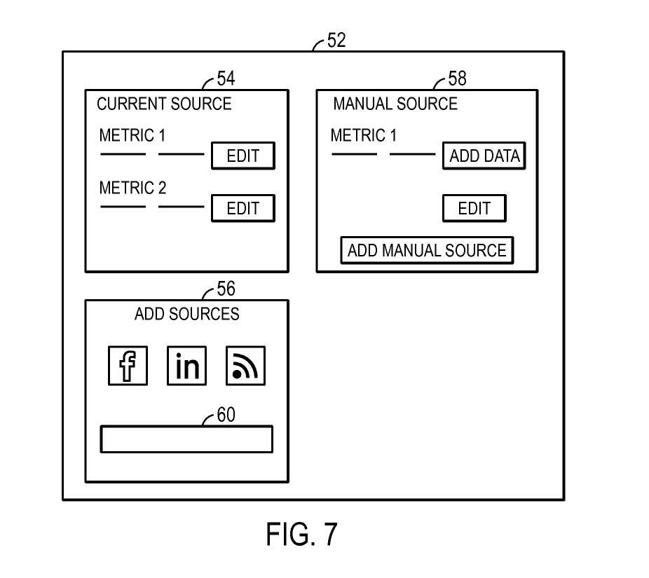

The data source interface 52 may include a current sources section 54, an add sources section 56, and a manual sources section 58, as illustrated in FIG. 7. The current sources section 54 may display all of the 3^{rd} party and proprietary data sources that provide data for each metric displayed in the dashboard software for the end user 36. The end user 36 may be able to edit various properties of the data sources listed in the current sources section 54 (e.g., how often a source is polled for new data) or even remove data sources from a particular metric.

To add new 3^{rd} party and proprietary data sources, the end user 36 may use the add sources section 56. The add sources section 56 may include a set of popular 3^{rd} party data sources 42 listed or denoted by icons. The add sources section may also include an input field 60 to allow the end user to select other 3^{rd} party or proprietary data sources. In embodiments that include the input field 60, the add sources section may include a “submit” feature that allows the end user 36 to send a notification to the software company detailing the particular data source added. This may allow the software developers to check the APIs associated with the data sources for any API-specific issues that should be addressed through algorithms in the data connections layer 22. It may also inform the software developers as to what popular data sources should be listed in the add sources section 56.

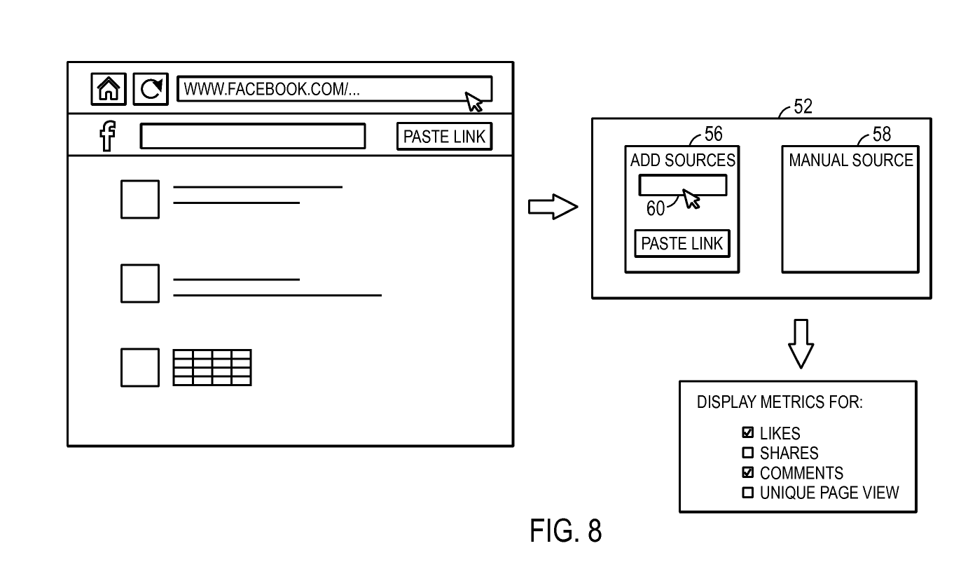

In certain embodiments, the end user 36 may be able to enter a URL into the input field 60 to create one or more metrics based on the data contained in the webpage identified by the URL, as illustrated in FIG. 8. For example, the end user 36 may wish to create metrics associated with the number of likes and comments for a Facebook post. As shown, the end user 36 may copy-and-paste the URL for the Facebook post into the input field 60. This may generate a widget editing interface, described in further detail below, which allows the end user 36 to create and/or select the desired metrics and add them to a new custom widget.

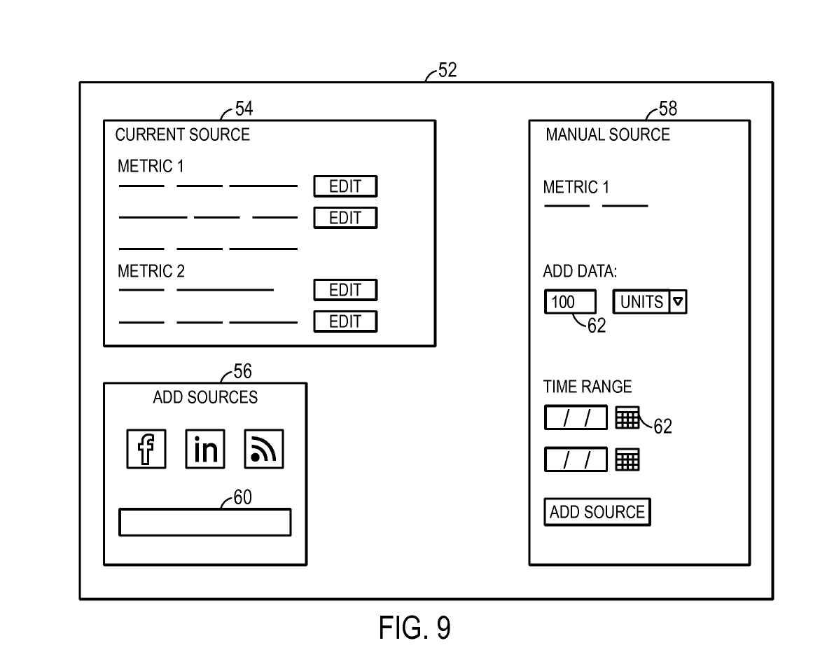

The end user 36 may generally add and/or edit the manual sources 46 within the manual sources section 58. The end user 36 may enter in data (e.g., amount of units, percentage of issues resolved, etc.) and the time range for the measured data (e.g., month, year, etc.) into data input fields 62, as shown in FIG. 9. In other embodiments, the end user 36 may upload a text or spreadsheet file containing data to create the manual source 46.

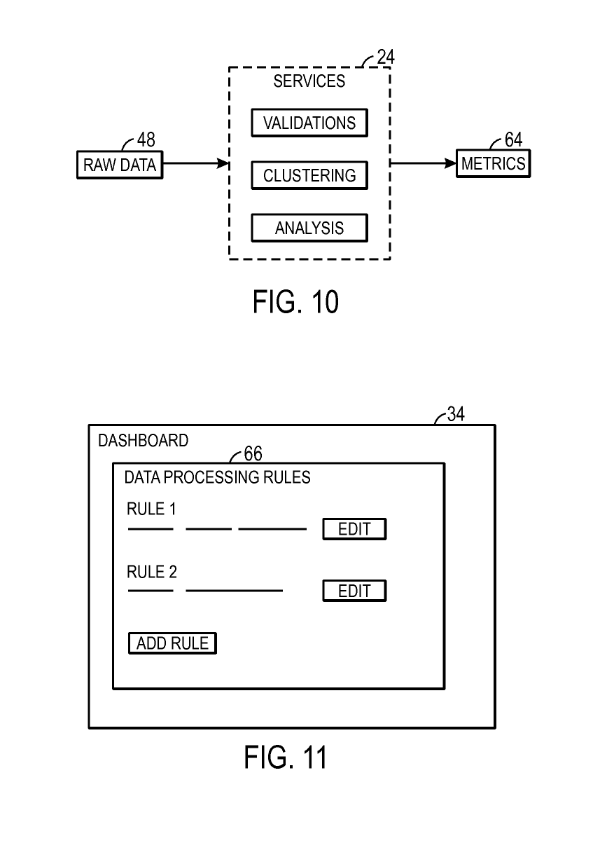

The raw data 48 gathered by data connections layer 22 may then be passed to the services layer 24, as shown in FIG. 10. The services layer 24 may provide data validation to ensure that the data gathered from the data connection layer 22 is safe and reliable. The services layer 24 may also include data processing (e.g., clustering, analysis, etc.) via adaptive algorithms to produce metrics 64.

In certain embodiments, the adaptive algorithms within the services layer 24 may include user-defined rules as to how raw data 48 should be stored, analyzed, and visualized. For example, an end user 36 may wish to filter out any social media data that is inappropriate for the work place. Or, the end user 36 may wish to set an alert to be notified when a metric reaches a particular state (e.g., jacket sales exceed 500,000 units).

The end user 36 may create and edit data processing rules via a services interface 66 within the dashboard layer 34, as illustrated in FIG. 11. When editing data processing rules, the services interface 66 may present a range of common data processing techniques, such as adding two related sets of data, in a format similar to other analytics applications (e.g. Microsoft Excel). The end user 36 may also set alerts for individual metrics within the services interface 66. The services interface may be accessed via a button in other interfaces within the dashboard layer 34, such as the dashboard interface 38 and the data source interface 52. Alternately or additionally, the end user 36 may select a widget 40 (e.g. tap and hold, right-click, etc.) to prompt a list of actions that includes editing the rules and alerts for the widget via the services interface 66.

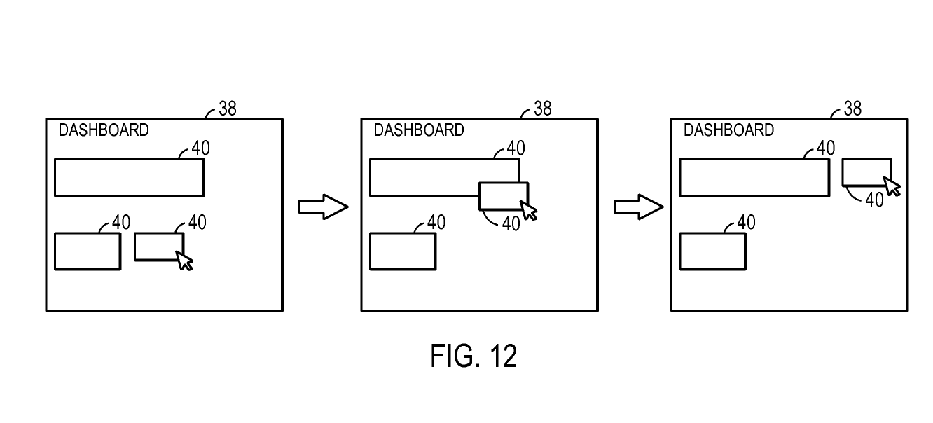

As mentioned above, the metrics displayed within the dashboard interface 38 may generally be organized into one or more widgets 40. The end user 36 may rearrange the widgets 40 on the dashboard interface 38 via a drag-and-drop mechanism, as illustrated in FIG. 12.

The definitions of each widget may be stored within a data structure in the widget definitions layer 26. Pre-defined widgets 40 for popular data sources such as Facebook, Twitter, and LinkedIn may automatically be included in the dashboard software 20. Alternately and additionally, the end user 36 may create custom widgets 40 that incorporate different metrics from a variety of data sources 42, 44, and 46. As a result, the end user 36 may control not only the spatial arrangement of the metrics displayed but also the actual data he or she is presented.

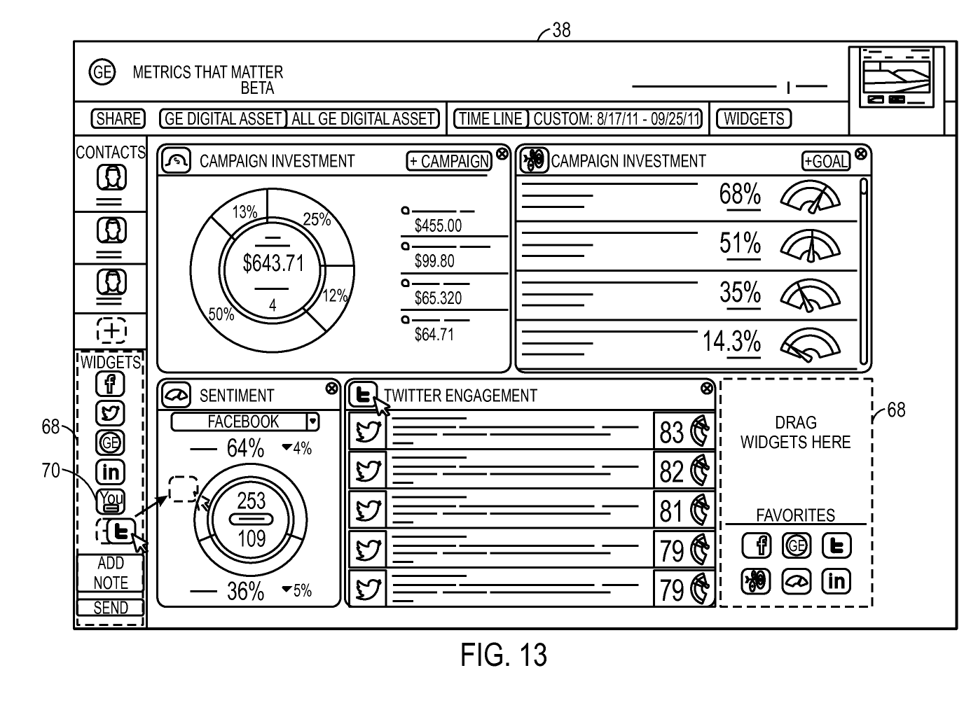

The dashboard software 20 may include two “locations” from which the end user 36 can acquire a widget 40. The dashboard interface 38 may include a selection panel 68 that may contain one or more icons 70 that represent widgets 40, as shown in FIG. 13. If the end user 36 wants to add a widget, he or she may drag and drop an icon 70 onto the main area of the dashboard interface 38. The number of icons 70 displayed in the selection panel 68 may vary based on the size of the selection panel 60. Further, the icons 70 displayed in the selection panel 68 may only be restricted to pre-defined widgets 40. Alternately and additionally, if the main area of the dashboard interface 38 contains an empty space, a selection panel 68 may be located in the empty space.

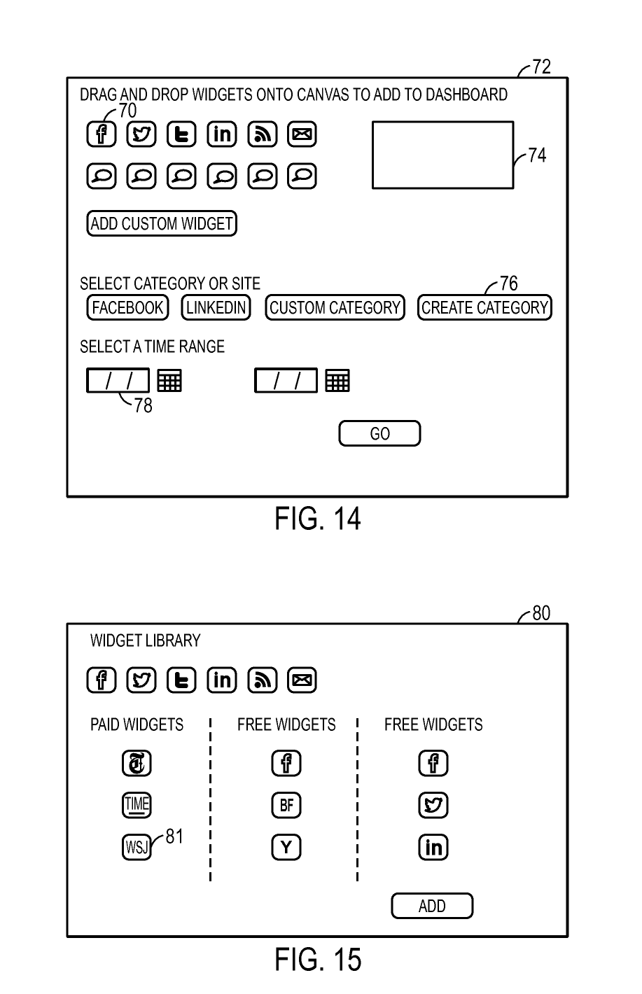

Because the selection panel 68 may depict only a subset of the widgets available, the end user 36 may expand the selection panel 68 into a selection interface 72 to view a full list of the widgets 40. The selection interface 72 may include an icon 70 for each pre-defined and custom widget, as illustrated in FIG. 14. The end user 36 may drag and drop the desired icons 70 onto a canvas 74 to add the associated widgets 40 to the dashboard interface 38.

In certain embodiments of the dashboard software 20, the end user may select a category of widgets 40 to add to the dashboard interface 38 via the selection interface. For example, the end user 36 may choose to display any widgets containing data collected from LinkedIn. Additionally, the end user 36 may create custom categories of widgets. The end user 36 may create rules within the services layer 24 that designate which metrics fall under a particular category. To that end, the selection interface 72 may contain a create category button 76 that prompts the services interface 66.

When adding widgets 40 via the selection interface 72, the end user 36 may also select a time range 78 that limits the amount of data displayed for a metric. In certain embodiments, the dashboard software 20 may display an error message if the end user 36 attempts to select a time range 78 for which data is unavailable. Alternately or additionally, the end user 36 may be able to select that all available data, rather than that limited to a particular time range 78, be displayed. This option may be presented within the selection interface 72 or within the user settings. In other embodiments, the end user 36 may select a widget 40 (e.g. clicking, double tapping) to prompt a list of actions that includes changing the time range 78.

The end user 36 may also acquire widgets 40 from the widget library layer 28, which may include a data structure containing widgets created by other end users. The widget library layer 28 may not be stored within each copy of the dashboard software 20 but may instead be stored on a separate non-transitory computer readable medium (e.g., server, central computer, etc.) and accessed via a communications link (e.g., local area network (LAN) connection).

A widget library interface 80 may include lists of widgets organized into one or more categories, as illustrated in FIG. 15. The widget library layer 28 may include both free and paid widgets. The end user 36 may select one or more icons 81 to add the associated widgets 40 to the dashboard interface 38. Any information associated with the widgets 40 (e.g. data sources, services rules, etc.) may then be automatically added to the dashboard software 20.

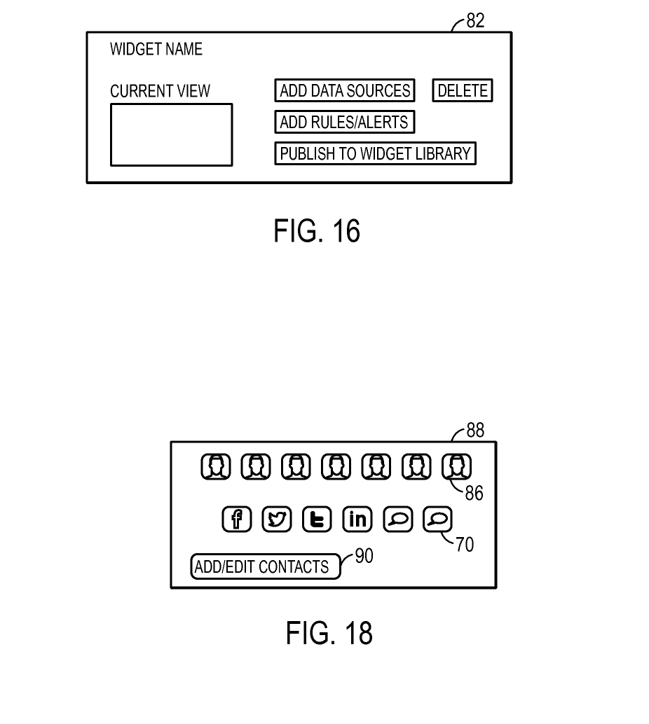

As mentioned above, the end user 36 may create widgets that incorporate disparate types of metrics from different sources based on his or her needs. Such actions may be performed via a widget editing interface 82, as illustrated in FIG. 16. The widget editing interface 82 may be accessed by selecting a widget 40 within the dashboard interface 38, or through an edit button listed in the selection panel 60 and/or the selection interface 72.

Each widget 40 may include at least a title and one or more visualizations displaying the metrics, which the end user 36 may edit via the widget editing interface 82. The visualizations may be stored in a data structure within the visualizations layer 30. In some embodiments of the dashboard software 20, the end user 36 may choose any visualization to display a given metric.

Alternately or additionally, the end user 36 may select the title displayed in a widget 40 to generate a text input field in which he or she may edit the title. Similarly, the end user 36 may select the visualization displayed in a widget 40 on the dashboard interface 38 to prompt an interface in which he or she changes the visualization. Further, in some embodiments of the dashboard software 20, the end user 36 may be able to acquire visualizations from the widget library layer 28 in a manner similar to widgets.

Referring again to FIG. 16, the widget editing interface 82 may also include links to other interfaces. For example, the widget editing interface may contain a button labeled “add data sources” that prompts the appropriate version of the data sources interface. A similar button and action may be included for adding and editing data processing rules and alerts. In embodiments that contain a widget library layer 28, the widget editing interface 82 may include a button and action for publishing custom widgets 40 in the widget library layer.

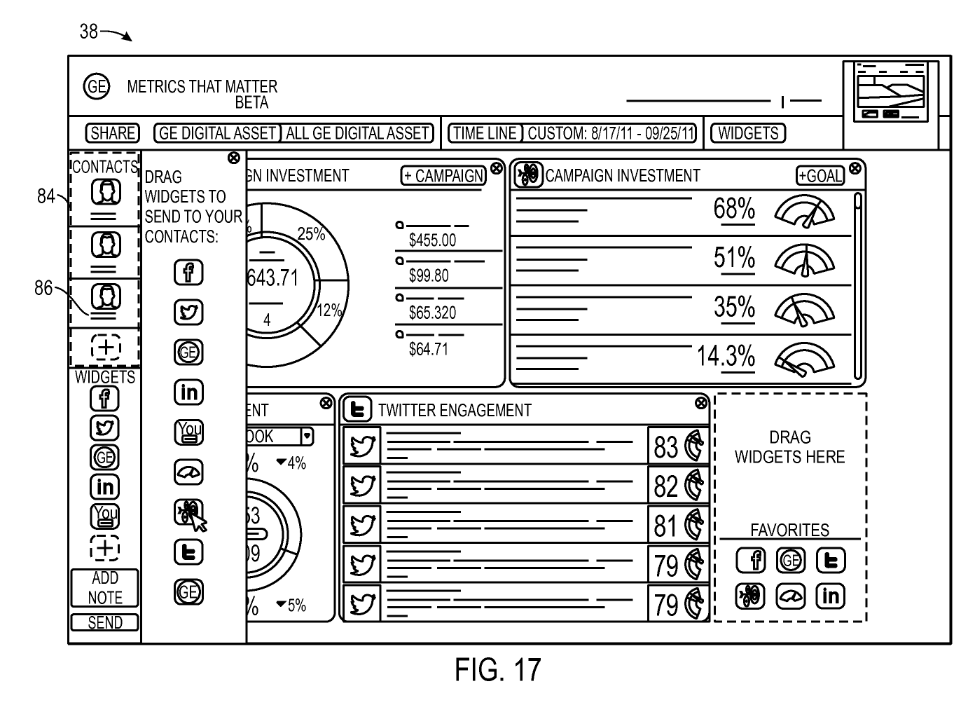

Turning now to FIG. 17, the dashboard interface 38 may also include a contacts panel 84 that includes one or more icons 86 representing the end user's contacts. The icons 86 may represent a single person or entity, or a group of people and entities. To share a widget 40 with a contact, the end user 36 may drag and drop the widget 40 onto the appropriate icon 86. The dashboard software 20 may then notify the contact (e.g., email, short messaging service (SMS), etc.).

The end user 36 may also expand the contacts panel 84 into a contacts interface 88, as depicted in FIG. 18. In the contacts interface 88, all of the end user's contacts and all of the widgets 40 may be represented by icons 86 and 70, respectively. The end user may drag and drop the icons 70 onto the desired icons 86 to share the associated widgets. The contacts interface 88 may also include an edit button 90 that prompts an interface allowing the end user 36 to add and edit contacts and contact groups (e.g. people within a group). Alternately or additionally, the contacts panel 84 may contain an edit button 90. The end user 36 may also prompt the editing interface by selecting the icon 86 representing a contact. Any information regarding contacts for an end user 36 may be stored within the team layer 32.

As will be appreciated, the dashboard layer 34 may include other interfaces related to viewing and editing user settings such as a profile picture, password reset, and notification settings (i.e., how to contact the user). Further, the dashboard software 20 may contain security features such as registering the specific devices (e.g., a laptop, a smart phone, etc.) used to access the software.

One or more of the disclosed embodiments, alone or in combination, may provide one or more technical effects useful for business dashboard software. Certain embodiments may allow an end user to install and maintain the business dashboard software. For instance, the present dashboard software may include a set of interfaces that allow the end user to perform the installation and to create and modify the main content (e.g., data sources, data processing rules, widgets, contacts, etc.) of the dashboard software. Other embodiments may allow for increased user customization and organization within the dashboard software. For example, the present dashboard software may treat data, data analysis rules, widget options, and visualization options independently, rather than restricting options for one set based on the other sets. Still other embodiments may allow end users to link various metrics to actions and decisions that result from the metrics. For example, the present dashboard software may allow end users to set alerts to be notified when a metric reaches a certain state. The technical effects and technical problems in the specification are exemplary and not limiting. It should be noted that the embodiments described in the specification may have other technical effects and can solve other technical problems.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system comprising:
a processor;
a memory;
a display; and
a user input device; wherein the processor is configured to access a widget library layer comprising a first data structure comprising a first plurality of widgets;
wherein the processor is configured to control a digital dashboard software comprising:
a data connections layer, wherein the data connections layer comprises a first set of algorithms configured to extract data from a first plurality of data sources and wherein the data from the first plurality of data sources is stored outside of the system;
a services layer, wherein the services layer comprises a second set of algorithms configured to perform at least one of validation, clustering, or analysis on data;
a widget definitions layer, wherein the widget definitions layer comprises a second data structure comprising a first set of data associated with a second plurality of widgets;
a dashboard layer, wherein the dashboard layer comprises a user interface structure comprising a plurality of user interfaces;
a visualizations layer, wherein the visualizations layer comprises a third data structure comprising a first plurality of visualizations; and
a team layer, wherein the team layer comprises a fourth data structure comprising a second set of data associated with a plurality of contacts;
wherein the processor is configured to download a first widget of the first plurality of widgets and store the first widget and a third set of data associated with the first widget within the digital dashboard software in response to end user input; and wherein at least one of the first plurality of data sources, the second set of algorithms, the second plurality of widgets, or the plurality of contacts is configured to be edited by an end user.

2. The system of claim 1, wherein the data connections layer further comprises a fifth data structure comprising a fourth set of data associated with a second plurality of data sources.

3. The system of claim 2, wherein the fourth set of data is configured to be edited by an end user.

4. The system of claim 2, wherein the fourth set of data is stored only within the digital dashboard software.

5. The system of claim 1, wherein the first data structure further comprises a second plurality of visualizations.

6. The system of claim 1, wherein the first plurality of data sources comprises a 3^{rd} party data source.

7. The system of claim 1, wherein the first plurality of data sources comprises an open data source.

8. The system of claim 1, wherein the second set of algorithms comprises an algorithm configured to set an alert associated with a metric within a widget.

9. The system of claim 1, wherein the user interface structure comprises a data source interface configured to display the first plurality of data sources, a services interface configured to display the second set of algorithms, a dashboard interface configured to display the second plurality of widgets, a widget editing interface configured to display customization options associated with the second plurality of widgets, a widget library layer configured to display the first plurality of widgets, and a contacts interface configured to display the third set of data.

10. The system of claim 1, wherein the first data structure further comprises a second plurality of visualizations.

11. A non-transitory computer-readable medium storing computer executable code comprising instructions to:
access a widget library layer comprising:
a first data structure comprising a first plurality of widgets;
run a digital dashboard application comprising:
a data connections layer, wherein the data connections layer comprises a first set of algorithms configured to extract data from a first plurality of data sources and wherein the data from the first plurality of data sources is stored outside of the non-transitory computer-readable medium;
a services layer, wherein the services layer comprises a second set of algorithms configured to perform at least one of validation, clustering, or analysis on extracted data;
a widget definitions layer, wherein the widget definitions layer comprises a second data structure comprising a first set of data associated with a second plurality of widgets;
a dashboard layer, wherein the dashboard layer comprises a user interface structure comprising a plurality of user interfaces;
a visualizations layer, wherein the visualizations layer comprises a data structure comprising a first plurality of visualizations; and
a team layer, wherein the team layer comprises a fourth data structure comprising a second set of data associated with a plurality of contacts; and
download a first widget of the first plurality of widgets and store the first widget and a third set of data associated with the first widget within the digital dashboard application in response to end user input.

12. The non-transitory computer-readable medium of claim 11, wherein the data connections layer further comprises a fifth data structure comprising a fourth set of data associated within a second plurality of data sources.

13. The non-transitory computer-readable medium of claim 12, wherein the fourth set of data is stored only within the digital dashboard application.

14. The non-transitory computer-readable medium of claim 11, wherein the computer executable code further comprises instructions to edit at least one of the first plurality of data sources or the second set of algorithms in response to end user input.

15. The non-transitory computer-readable medium of claim 11, wherein the first plurality of data sources comprises a 3^{rd} party data source.

16. The non-transitory computer-readable medium of claim 11, wherein the first plurality of data sources comprises an open data source.

17. The non-transitory computer-readable medium of claim 11, wherein the second set of algorithms comprises an algorithm configured to set an alert associated with a metric within a widget.

18. The non-transitory computer-readable medium of claim 11, wherein the first data structure further comprises a second plurality of visualizations.

19. The non-transitory computer-readable medium of claim 11, wherein the user interface structure comprises a data source interface configured to display the first plurality of data sources, a services interface configured to display the second set of algorithms, a dashboard interface configured to display the second plurality of widgets, a widget editing interface configured to display customization options associated with the second plurality of widgets, a widget library layer configured to display the first plurality of widgets, and a contacts interface configured to display the third set of data.

20. The non-transitory computer-readable medium of claim 11, wherein the computer executable code further comprises instructions to upload a second widget of the second plurality of widgets to the widget library layer.

21. The non-transitory computer-readable medium of claim 11, wherein the second plurality of widgets are configured to be shared with a first contact of the set of contacts.

22. A method comprising:
accessing a first plurality of widgets, wherein the first plurality of widgets are stored outside of a system;
extracting data from a first plurality of data sources according to a first set of algorithms, wherein the data is stored outside of the system;
performing an action on the extracted data according to a second set of algorithms, wherein the action comprises at least one of validation, clustering, or analysis;
displaying a second plurality of widgets;
organizing the second plurality of widgets in response to user input;
editing the second plurality of widgets and a first set of data associated with the second plurality of widgets;
displaying a plurality of contacts;
sharing a first widget of the second plurality of widgets with a contact of the plurality of contacts; and
downloading a second widget of the first plurality of widgets and storing the second widget and a second set of data associated with the widget within the system.

23. The method of claim 22, wherein the method further comprises storing data from a second plurality of data sources in response to end user input and wherein the data is stored only within the system.

24. The method of claim 22, wherein the method further comprises editing at least one of the first plurality of data sources or second set of algorithms in response to end user input.

25. The method of claim 22, wherein the method further comprises uploading a third widget of the second plurality of widgets to a data structure outside of the system.
